(19) United States
(12) Patent Application Publication
(10) Pub. No.: US 2016/0184980 A1
(43) Pub. Date: Jun. 30, 2016

(54) PINCHING TOOL

(71) Applicant: ENGINEER INC., Osaka (JP)

(72) Inventors: Mitsuhiro TAKASAKI, Osaka (JP); Shinnosuke KAWAI, Osaka (JP); Masanori ANDO, Osaka (JP); Mayu FUKUDA, Osaka (JP)

(21) Appl. No.: 14/656,956

(22) Filed: Mar. 13, 2015

(30) Foreign Application Priority Data
Dec. 25, 2014 (JP) 2014-263469

(51) Int. Cl. B25B 7/02; B26B 13/22; B25F 1/00

(52) U.S. Cl. CPC B25B 7/02; B25F 1/003; B26B 13/22

(57) ABSTRACT

There is provided a pinching tool capable of reliably pinching an object by a pair of pinching teeth each having a continuous mountain-valley shape and accurately performing a secondary operation on the object pinched between the pinching teeth. A first arm 1 and a second arm 2 each of which has a jaw 4 arranged on the front end and a grip 5 arranged on the rear end side are coupled in an X shape by coupling bosses 6 arranged on the arms 1, 2 adjacent to the jaws 4 and a coupling shaft 3. Lateral pinching teeth 11 are formed on front parts of opposed surfaces of the pair of jaws 4. Each of the lateral pinching teeth 11 includes a plurality of lateral rib teeth 17 which extend in a direction intersecting a tool central axis 8 and are continuous in a mountain-valley shape. The lateral rib teeth 17 formed on one of the jaws 4 and the lateral rib teeth 17 formed on the other jaw 4 are shifted in the front-rear direction so that mountain portions 17a of the lateral rib teeth 17 of one of the jaws 4 enter valley portions 17b of the lateral rib teeth 17 of the other jaw 4 when the first arm 1 and the second arm 2 are gripped up to the limit position.

### BACKGROUND OF THE INVENTION

(1) Field of the Invention

The present invention relates to a pinching tool which includes a pair of pinching arms each having a jaw and a grip, the pinching arms being coupled in an X shape by a coupling shaft and also relates to a technique for improving a grasping function. Specific examples of the pinching tool according to the present invention include pliers, combination pliers, cutting pliers, needle-nose pliers, and water pump pliers.

(2) Description of Related Art

Forming pinching teeth each having a mountain-valley shape on the respective opposed surfaces of a pair of jaws is a widely known technique in the field of pinching tools. For example, JP 50-148198 Y (FIG. 1 and FIG. 2) discloses cutting pliers provided with a pair of arms each of which has a jaw arranged on the front end and a grip arranged on the rear end, a coupling shaft which couples the arms in an X shape, and pinching teeth each having a mountain-valley shape formed on the respective opposed surfaces of the jaws.

In the cutting pliers of JP 50-148198 Y, a pair of cutting blades is formed on opposed surfaces of the jaws adjacent to the coupling shaft. The edges of the cutting blades come into contact with each other to define the gripping limit of both of the arms. Further, in the cutting pliers of JP 50-148198 Y, a small gap is formed between mountain portions of the pinching teeth of the jaws in the gripping limit. Thus, it is not possible for the cutting pliers of JP 50-148198 Y to pinch a sheet body having a thickness dimension smaller than the dimension of the gap formed between the pinching teeth in the gripping limit. In other words, the cutting pliers of JP 50-148198 Y assign priorities to a cutting function deriving from the cutting blades. Thus, a grasping function deriving from the pinching teeth is not sufficiently exhibited.

In this kind of pinching tools, there is a pinching tool having a configuration in which pinching teeth of jaws come into contact with each other in the gripping limit in order to assign priorities to a grasping function deriving from the pinching teeth to enable the pinching tool to pinch a thin sheet body. However, in such a configuration in which pinching teeth come into contact with each other, when the contact state between the pinching teeth in the gripping limit is uneven, an excellent grasping function cannot be obtained. That is, when the contact state between the pinching teeth in the gripping limit is uneven and some of the pinching teeth therefore first abut on each other in the gripping limit, only the pinching teeth first abutting on each other come into contact with an object to be pinched when the object is grasped and the other pinching teeth are not involved in the pinching action. As a result, a reliable grasping function using many pinching teeth is not exhibited.

### SUMMARY OF THE INVENTION

The present invention has been made for solving the above problems in conventional pinching tools, and an object thereof is to provide a pinching tool having an excellent grasping function capable of reliably pinching even a thin sheet body.

Another object of the present invention is to provide a pinching tool sufficiently exhibiting both a cutting function deriving from cutting blades and a grasping function deriving from pinching teeth.

The present invention is directed to a pinching tool which includes a pair of arms 1, 2 each having a jaw 4 arranged on an front end side and a grip 5 arranged on a rear end side, coupling bosses 6 and a coupling shaft 3 for coupling the arms 1, 2 in an X shape, and lateral pinching teeth 11 formed on front parts of opposed surfaces of the jaws 4 of both of the arms 1, 2. A stopper 18 for restricting a gripping limit of the jaws 4 of both of the arms 1, 2 when the grips 5 are gripped is disposed between the arms 1, 2. Each of the lateral pinching teeth 11 includes a plurality of lateral rib teeth 17 extending in a direction intersecting a tool central axis 8 extending in a front-rear direction, the lateral rib teeth 17 being continuous in a mountain-valley shape. When a region located on the front side with respect to the rearmost lateral rib tooth 17 of each of the jaws 4 is defined as a front region 23, the stopper 18 is disposed on a portion excepting the front region 23. The lateral rib teeth 17 formed on one of the jaws 4 and the lateral rib teeth 17 formed on the other jaw 4 are shifted in the front-rear direction. Mountain portions 17a of the lateral rib teeth 17 of one of the jaws 4 enter valley portions 17b of the lateral rib teeth 17 of the other jaw 4 and the front regions 23, 23 of both of the jaws 4, 4 including the lateral rib teeth 17 contactlessly face each other in a closed posture obtained by gripping the arms 1, 2 up to the gripping limit defined by the stopper 18.

A pair of cutting blades 10, 10 is formed on opposed surfaces of the jaws 4 adjacent to the coupling bosses 6, and the cutting blades 10, 10 come into contact with each other to function as the stopper 18.

The lateral pinching teeth 11 formed on both of the jaws 4 include lateral rib teeth 17 having the same shape, the same size, and the same tooth pitch P. The tooth pitch P of the lateral rib teeth 17 formed on one of the jaws 4 and the tooth pitch P of the lateral rib teeth 17 formed on the other jaw 4 are shifted by half the tooth pitch P in the front-rear direction. Tips of the mountain portions 17a of the lateral rib teeth 17 formed on one of the jaws 4 and bottom ends of the valley portions 17b of the lateral rib teeth 17 formed on the other jaw 4 contactlessly face each other in the up-down direction in the closed posture.

The lateral pinching tooth 11 of each of the jaws 4, 4 includes a plurality of kinds of lateral rib teeth 17 having different tooth pitches P1, P2, the lateral rib teeth 17 being arranged along the tool central axis 8.

The tips of the mountain portions 17a and the bottom ends of the valley portions 17b of the lateral rib teeth 17 are rounded so that the lateral pinching tooth 11 of each of the arms 1, 2 is formed in a continuous wave shape in side view.

The lateral pinching tooth 11 of each of the arms 1, 2 includes a plurality of kinds of lateral rib teeth 17 having different tooth heights (H).

Tooth mounts 15 are formed in a projecting manner on front parts of opposed surfaces of the pair of jaws 4. Lateral pinching teeth 11 are formed on the right and left sides of each of the tooth mounts 15 and a longitudinal pinching tooth 12 is formed between the right and left lateral pinching teeth 11. Each of the lateral pinching teeth 11 includes a plurality of lateral rib teeth 17 extending perpendicular to the tool central axis 8. The longitudinal pinching tooth 12 includes a plurality of longitudinal rib teeth 20 elongated in the front-rear direction.

A front end 21 of each of the tooth mounts 15 is formed in a flat surface perpendicular to the tool central axis 8. The longitudinal rib teeth 20 are formed in a recessed arc shape from the front end 21 through a rear end of each of the tooth mounts 15. Front parts of the longitudinal rib teeth 20 face the front end 21 of each of the tooth mounts 15.

### Effects of the Invention

In the pinching tool according to the present invention, the mountain portions 17a of the lateral rib teeth 17 of one of the jaws 4 enter the valley portions 17b of the lateral rib teeth 17 of the other jaw 4 in the closed posture obtained by gripping the first arm 1 and the second arm 2 up to the gripping limit defined by the stopper 18. In such a configuration in which the mountain portions 17a of the lateral rib teeth 17 of one of the jaws 4 enter the valley portions 17b of the lateral rib teeth 17 of the other jaw 4, when an object having a small thickness dimension, for example, a sheet body 100 is pinched by the lateral pinching teeth 11, it is possible to allow the tips of the mountain portions 17a of the opposed lateral rib teeth 17 to alternately abut on both surfaces of the pinched object. Thus, the object can be firmly pinched and fixed. In particular, when a sheet body 100 having flexibility is pinched, it is possible to firmly pinch and fix the sheet body 100 while bending and deforming the sheet body 100 pinched between the opposed lateral rib teeth 17. Therefore, the present invention makes it possible to reliably pinch an object having a small thickness dimension by the lateral pinching teeth 11, and obtain a pinching tool having an excellent grasping function. Further, the pinching tool according to the present invention makes it possible to accurately perform a secondary operation, for example, applying an external force to an object pinched by the lateral pinching teeth 11 to bend the pinched portion or pulling and separating the pinched object along with the pinched portion.

In addition, in the pinching tool according to the present invention, the stopper 18 is disposed in a portion excepting the front region 23 located on the front side with respect to the rearmost lateral rib tooth 17 of each of the jaws 4, and the front regions 23, 23 of both of the jaws 4, 4 including the lateral rib teeth 17 contactlessly face each other in the closed posture. That is, in the pinching tool according to the present invention, as described above, the mountain portions 17a of the lateral rib teeth 17 of one of the jaws 4 enter the valley portions 17b of the lateral rib teeth 17 of the other jaw 4 in the closed posture, and, at the same time, the lateral rib teeth 17 contactlessly face each other in the closed posture. In this manner, when the front regions 23, 23 of both of the jaws 4, 4 including the lateral rib teeth 17 contactlessly face each other in the closed posture, it is possible to reliably allow a wider part of each of the lateral pinching teeth 11 to come into contact with an object to be pinched compared to the form in which lateral rib teeth 17 have contact with each other in the closed posture. Thus, it is possible to firmly pinch and fix an object and obtain a pinching tool having an excellent grasping function also in this point. Further, the above effect can be obtained merely by preventing the front regions 23, 23 of both of the jaws 4, 4 including the lateral rib teeth 17 from making contact with each other in the closed posture. Thus, the accuracy in the dimension of the lateral rib teeth 17 and the like is not strictly required. Therefore, it is also possible to advantageously simplify the structure of the pinching tool to achieve cost reduction. In other words, the present invention makes it possible to provide the pinching tool having an excellent grasping function at a low cost.

In addition, in the present invention, the front regions 23, 23 of both of the jaws 4, 4 including the lateral rib teeth 17 contactlessly face each other in the closed posture. Thus, when the both of the arms 1, 2 are gripped, it is possible to reliably allow the edges of the cutting blades 10, 10 to first abut on each other. In the above manner, the present invention makes it possible to obtain the pinching tool having both an excellent grasping function deriving from the lateral rib teeth 17 and an excellent cutting function deriving from the cutting blades 10.

The pinching tool that includes the pair of cutting blades 10 formed on the opposed surfaces of the jaws 4 adjacent to the coupling bosses 6 makes it possible to make the pinching tool further multifunctional by the addition of the cutting function and improve the usability of the pinching tool. Further, when the cutting blades 10 also serve as the stopper 18 which defines the gripping limit of the first arm 1 and the second arm 2, it is not necessary to provide an additional stopper 18. Thus, it is possible to simplify the structure of the pinching tool to achieve cost reduction. The cutting blades 10 can be used for cutting, for example, a cab tire cord or a metal wire material.

When the tooth pitch P of the lateral rib teeth 17 formed on one of the jaws 4 and the tooth pitch P of the lateral rib teeth 17 formed on the other jaw 4 are shifted by half the tooth pitch Pin the front-rear direction, it is possible to allow the tips of the mountain portions 17a of the lateral rib teeth 17 formed on one of the jaws 4 and the bottom ends of the valley portions 17b of the lateral rib teeth 17 formed on the other jaw 4 to face each other in the closed posture obtained by gripping the first arm 1 and the second arm 2 up to the gripping limit. Thus, when an object, for example, the sheet body 100 is pinched by the lateral pinching teeth 11, it is possible to further firmly pinch the object by elastically or plastically deforming the pinched object along the uneven shape of the opposed lateral rib teeth 17 to increase the contact friction between the lateral rib teeth 17 and the pinched object. Further, it is possible to reliably pinch even an object that is thin and thus easily deformed by deforming both surfaces of the pinched object by the lateral rib teeth 17 formed on one of the jaws 4 to prevent the lateral rib teeth 17 and the pinched object from relatively slipping on each other.

When each of the lateral pinching teeth 11 includes a plurality of kinds of lateral rib teeth 17 having different tooth pitches P1, P2, it is possible to variously change a pinching state by changing the position of an object pinched by the lateral pinching teeth 11. For example, an object maybe pinched by the lateral rib teeth 17 having the small tooth pitch P2, may be pinched by the lateral rib teeth 17 having the large tooth pitch P1, or may be pinched by the lateral rib teeth 17 having the small tooth pitch P2 and the lateral rib teeth 17 having the large tooth pitch P1. Thus, the pinching state by the lateral pinching teeth 11 may be variously changed depending on, for example, a difference in the material or the thickness of an object to be pinched. When an object is pinched by the lateral rib teeth 17 having the large tooth pitch P1, it is possible to increase the contact area between the lateral rib teeth 17 and the pinched object to thereby reliably prevent the lateral rib teeth 17 and the pinched object from relatively slipping on each other.

The pinching tool that includes the lateral pinching teeth 11 each having a continuous wave shape in side view makes it possible, in a state in which an object, for example, the sheet body 100 is pinched by the lateral pinching teeth 11, to gently deform the object while reliably pinching the object to prevent the pinched object from being damaged. Further, the degree of deformation of the pinched object is gentle. Thus, it is possible to lightly pinch the object with a smaller force compared to the case when mountain portions 17a of the lateral rib teeth 17 are sharpened to have an acute angle.

When each of the lateral pinching teeth 11 includes a plurality of kinds of lateral rib teeth 17 having different tooth heights H, it is possible to variously change a pinching state by changing the position of an object pinched by the lateral pinching teeth 11. For example, an object may be pinched by the lateral rib teeth 17 having a small tooth height H, may be pinched by the lateral rib teeth 17 having a large tooth height H, or may be pinched by the lateral rib teeth 17 having a small tooth height H and the lateral rib teeth 17 having a large tooth height H. Thus, the pinching state by the lateral pinching teeth 11 may be variously changed depending on, for example, a difference in the material or the thickness of an object to be pinched. When an object is pinched by the lateral rib teeth 17 having a large tooth height H, it is possible to increase the contact area between the lateral rib teeth 17 and the pinched object to thereby reliably prevent the lateral rib teeth 17 and the pinched object from relatively slipping on each other.

When lateral pinching teeth 11 are formed on the right and left sides of each of the tooth mounts 15 and each longitudinal pinching tooth 12 is formed between the right and left lateral pinching teeth 11, it is possible to suitably pinch and treat objects having different shapes or different structures by the lateral pinching teeth 11 and the longitudinal pinching teeth 12. Thus, it is possible to make the pinching tool multifunctional. For example, it is possible to perform a secondary operation, for example, pinching and bending an object, for example, the sheet body 100 by the lateral pinching teeth 11 or pulling out the pinched object. Further, it is possible to reliably remove a screw that cannot be loosened by a driver by pinching the head of the screw by the longitudinal pinching teeth 12 and rotating the screw in the loosening direction. Under certain circumstances, a screw that cannot be loosened by a driver can be removed using the lateral pinching teeth 11.

When the longitudinal rib teeth 20 are formed in a recessed arc shape from the front end 21 through the rear end of each of the tooth mounts 15 and the front parts of the longitudinal rib teeth 20 face the front end 21 of each of the tooth mounts 15, it is possible, when the longitudinal rib teeth 20 pinch the head of a screw, to pinch the circular arc peripheral surface of the screw head by the front parts of the longitudinal rib teeth 20 at the side closer to the screw fastening surface. Thus, it is possible to further reliably pinch the circular arc peripheral surface of the screw head by the longitudinal rib teeth 20 and further reliably remove the screw that cannot be loosened by a driver.

### BRIEF DESCRIPTION OF THE DRAWINGS

FIG. 1 is a side view of a principal part of a pinching tool according to a first embodiment of the present invention;

FIG. 2 is a perspective view of the pinching tool according to the first embodiment;

FIG. 3 is a side view showing the structure of jaws of the pinching tool;

FIG. 4 is a perspective view of the pinching tool with the jaws open;

FIG. 5 is a cross-sectional view taken along line A-A in FIG. 3;

FIG. 6 is a side view showing a state in which lateral pinching teeth start pinching a sheet body;

FIG. 7 is a side view showing a state in which the lateral pinching teeth have pinched the sheet body;

FIG. 8A is a right side view of the pinching tool according to the first embodiment;

FIG. 8B is a left side view of the pinching tool according to the first embodiment;

FIG. 8C is a front view of the pinching tool according to the first embodiment;

FIG. 8D is a rear view of the pinching tool according to the first embodiment;

FIG. 8E is a plan view of the pinching tool according to the first embodiment;

FIG. 8F is a bottom view of the pinching tool according to the first embodiment;

FIG. 8G is a reference diagram illustrating lateral pinching teeth and longitudinal pinching teeth;

FIG. 9 is a side view showing a modification of the lateral pinching teeth;

FIG. 10 is a side view showing another modification of the lateral pinching teeth;

FIG. 11 is a side view showing still another modification of the lateral pinching teeth;

FIG. 12 is a side view showing still another modification of the lateral pinching teeth;

FIG. 13 is a side view showing still another modification of the lateral pinching teeth;

FIG. 14 is a side view showing still another modification of the lateral pinching teeth;

FIG. 15 is a perspective view of a principal part of a pinching tool according to a second embodiment of the present invention;

FIG. 16 is a perspective view of the pinching tool according to the second embodiment with jaws open;

FIG. 17 is a side view of lateral pinching teeth according to the second embodiment;

FIG. 18A is a right side view of the pinching tool according to the second embodiment;

FIG. 18B is a left side view of the pinching tool according to the second embodiment;

FIG. 18C is a front view of the pinching tool according to the second embodiment;

FIG. 18D is a rear view of the pinching tool according to the second embodiment;

FIG. 18E is a plan view of the pinching tool according to the second embodiment;

FIG. 18F is a bottom view of the pinching tool according to the second embodiment;

FIG. 18G is a reference diagram illustrating lateral pinching teeth;

FIG. 19 is a side view of a pinching tool according to a third embodiment;

FIG. 20 is a side view of the pinching tool showing a modification of a stopper;

FIG. 21 is a side view showing a pinching tool according to a fourth embodiment;

FIG. 22 is a side view showing a pinching tool according to a fifth embodiment;

FIG. 23 is a side view showing a pinching tool according to a sixth embodiment;

FIG. 24 is a side view showing a pinching tool according to a seventh embodiment;

FIG. 25 is a side view showing jaws of the pinching tool according to the seventh embodiment;

FIG. 26 is a cross-sectional view taken along line B-B in FIG. 25 according to the seventh embodiment;

FIG. 27A is a right side view of the pinching tool according to the seventh embodiment;

FIG. 27B is a left side view of the pinching tool according to the seventh embodiment;

FIG. 27C is a front view of the pinching tool according to the seventh embodiment;

FIG. 27D is a rear view of the pinching tool according to the seventh embodiment;

FIG. 27E is a plan view of the pinching tool according to the seventh embodiment;

FIG. 27F is a bottom view of the pinching tool according to the seventh embodiment;

FIG. 27G is a reference diagram illustrating lateral pinching teeth; and

FIG. 28 is a diagram showing the shape of lateral pinching teeth of a pinching tool according to a modification of the seventh embodiment.

### DETAILED DESCRIPTION OF PREFERRED EMBODIMENTS

### First Embodiment

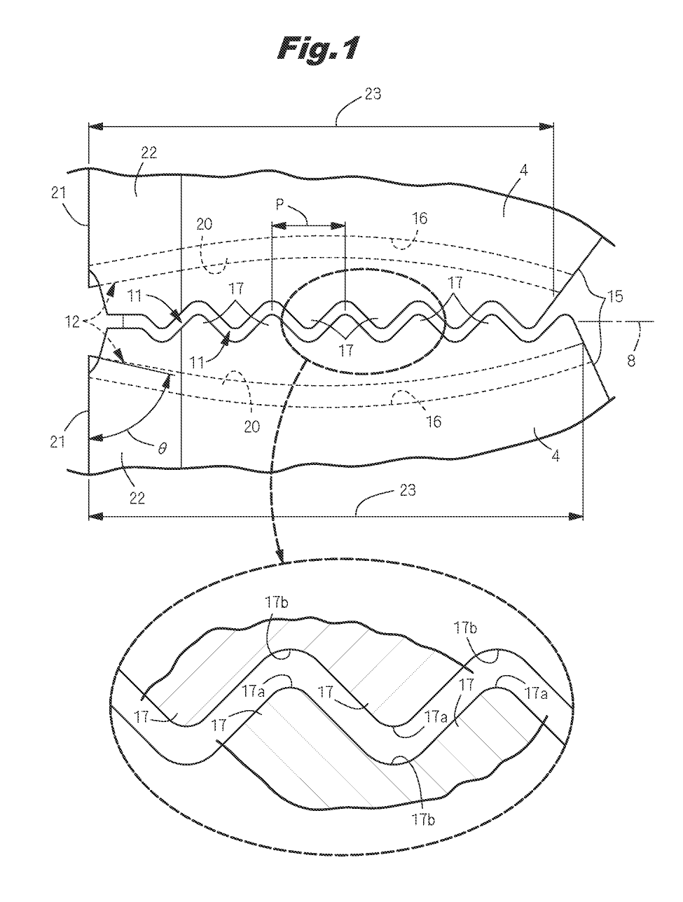

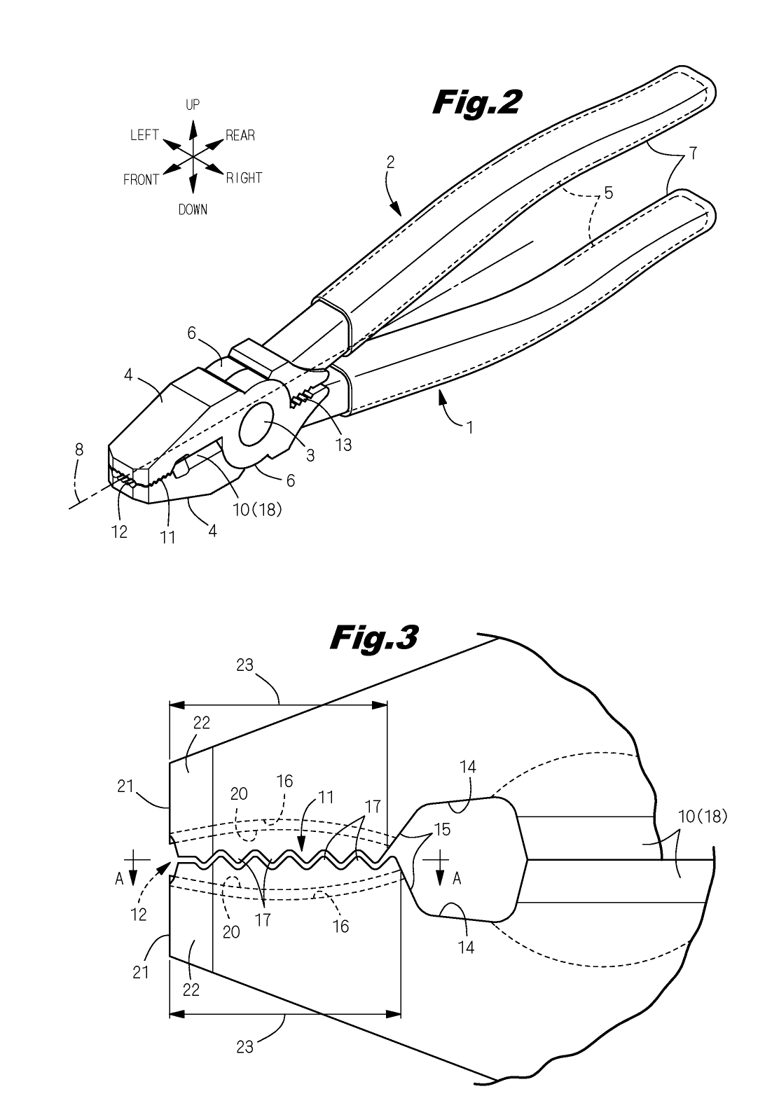

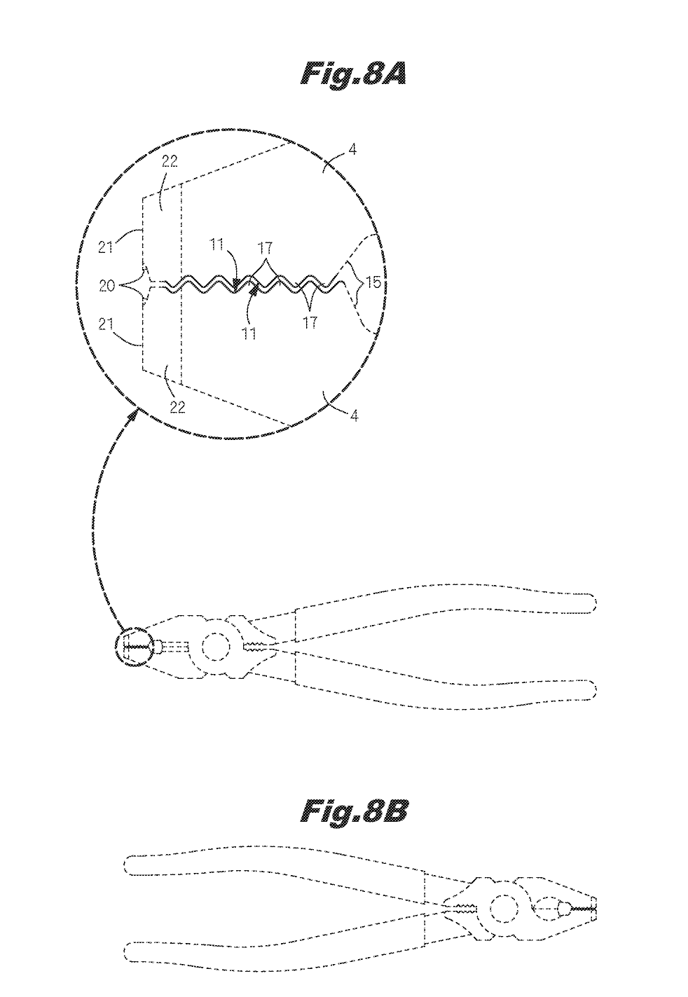

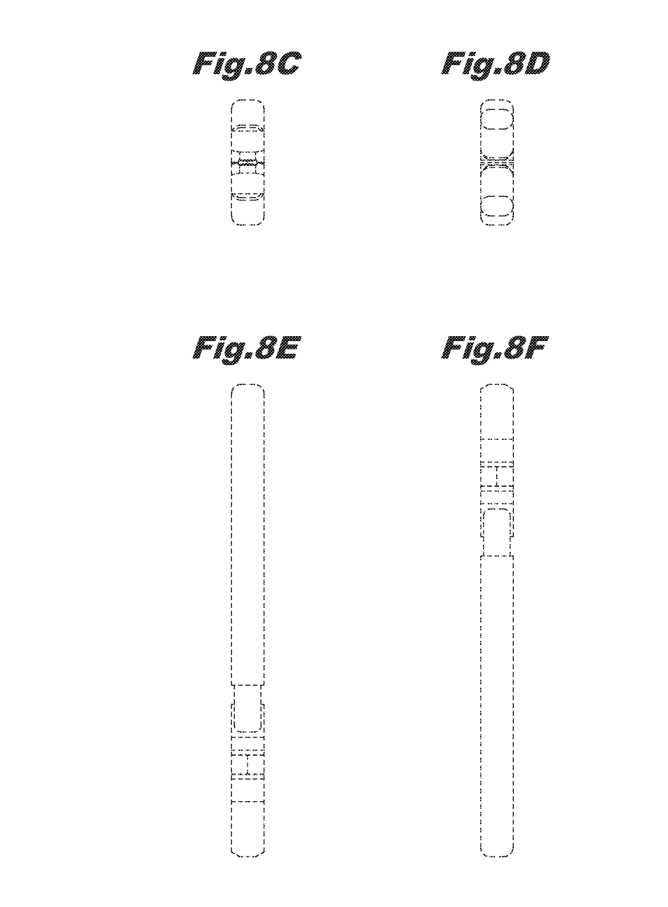

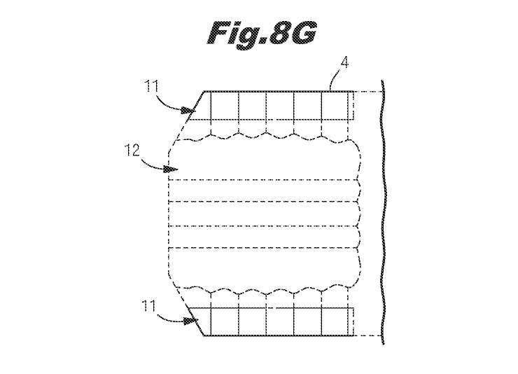

FIGS. 1 to 8G show a first embodiment in which a pinching tool according to the present invention is applied to cutting pliers. In the present embodiment, the front and rear, right and left, and up and down directions follow intersecting arrows illustrated in FIG. 2 and “front”, “rear”, “right”, “left”, “up”, and “down” written near the arrows. In FIG. 2, the cutting pliers include a first arm 1 and a second arm 2 which are arranged in an X shape and relatively turnably coupled by a coupling shaft 3. Each of the arms 1, 2 is composed of a forged product which includes a jaw 4 arranged on the front end, a curved grip 5 arranged on the rear end side, and a coupling boss 6 arranged on the base end of the jaw 4. Each of the arms 1, 2 is finished by grinding the right and left side surfaces and upper and lower surfaces of the jaw 4. The first arm 1 and the second arm 2 are substantially vertically symmetrically formed with respect to a tool central axis 8 passing through the center of the coupling shaft 3 as the axis of symmetry. The outer face of the grip 5 is covered with a grip body 7 made of elastomer. The coupling shaft 3 is fixed, for example, to the first arm 1 and relatively rotatably supported by the coupling boss 6 of the second arm 2. However, the coupling shaft 3 may be fixed to either the first arm 1 or the second arm 2. FIGS. 8A to 8F include six views showing the appearance of the cutting pliers according to the first embodiment.

A pair of cutting blades 10 for cutting, for example, a cab tire cord or a metal wire material is formed on opposed surfaces of the jaws 4 adjacent to the coupling bosses 6 (refer to FIG. 3). The cutting blades 10 in the present embodiment also serve as a stopper 18 which defines a gripping limit of the first arm 1 and the second arm 2. In the gripping limit, the edges of the cutting blades 10 are brought into intimate contact with each other in a straight line form. Relief recesses 14 are formed on the front side with respect to the pair of cutting blades 10. Tooth mounts 15 are formed on the front side with respect to the relief recesses 14. Lateral pinching teeth 11 and longitudinal pinching teeth 12 are formed on opposed surfaces of the tooth mounts 15. Further, rear pinching teeth 13 are formed on opposed surfaces of the grips 5 adjacent to the coupling bosses 6.

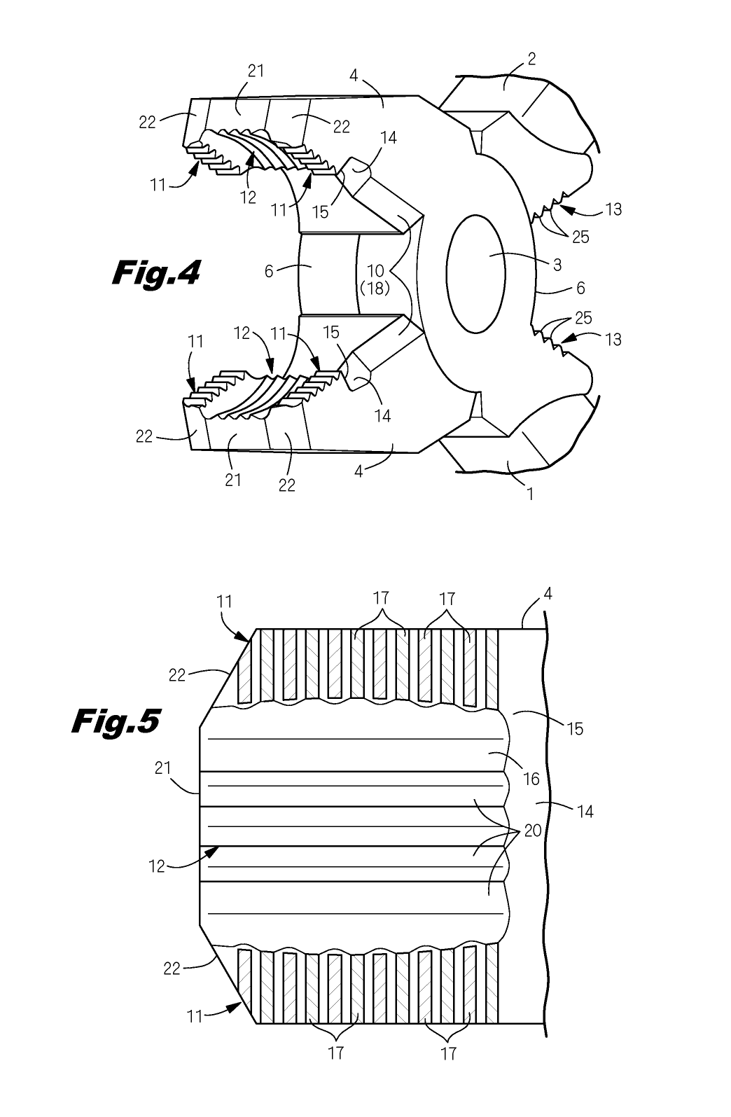

As shown in FIGS. 4 and 5, the lateral pinching teeth 11 are formed in a continuous mountain-valley state on the right and left sides of each of the tooth mounts 15. Each of the longitudinal pinching teeth 12 is formed in a continuous mountain-valley state on a recess 16 formed between the right and left lateral pinching teeth 11. As shown in FIG. 1, each of the lateral pinching teeth 11 includes a plurality of (five or six) lateral rib teeth 17 which extend in the right-left direction perpendicular to the tool central axis 8. In side view, the lateral rib teeth 17 formed on the jaw 4 of the first arm 1 and the lateral rib teeth 17 formed on the jaw 4 of the second arm 2 are formed in triangles having the same size and have the same tooth pitch P. In the cutting pliers according to the present embodiment, tips of mountain portions 17a and bottom ends of valley portions 17b of the lateral rib teeth 17 are rounded. When the height from the bottom ends of the valley portions 17b to the tips of the mountain portions 17a of the lateral rib teeth 17 is 0.6 mm, a radius value of the tips of the mountain portions 17a is 0.2 mm and a radius value of the bottom ends of the valley portions 17b is 0.3 mm.

As described above, the tooth pitch P of the lateral rib teeth 17 formed on the pair of jaws 4 is constant. However, the tooth pitch P of the lateral rib teeth 17 of the first arm 1 and the tooth pitch P of the lateral rib teeth 17 of the second arm 2 are shifted by half the tooth pitch P as shown in FIG. 1. Accordingly, it is possible to allow the mountain portions 17a of the lateral rib teeth 17 of one of the jaws 4 to enter the valley portions 17b of the lateral rib teeth 17 of the other jaw 4 in a state in which the first arm 1 and the second arm 2 are gripped up to the limit position, that is, in a state in which the cutting pliers are in a closed posture. Further, when the mountain portions 17a of the lateral rib teeth 17 of one of the jaws 4 enter the valley portions 17b of the lateral rib teeth 17 of the other jaw 4 in the cutting pliers in a closed posture in this manner, it is possible to reliably pinch and grasp even a sheet body 100 having a small thickness dimension by the lateral rib teeth 17. Details of the pinching action of the lateral rib teeth 17 will be described below. The tips of the mountain portions 17a and the bottom ends of the valley portions 17b face each other with a small gap of approximately 0.3 mm interposed therebetween.

Each of the longitudinal pinching teeth 12 includes a plurality of (four) longitudinal rib teeth 20 each of which is elongated in the front-rear direction and has a triangular cross section. As shown in FIG. 3, a front end 21 of each of the tooth mounts 15 is formed in a flat surface which is perpendicular to the tool central axis 8. The longitudinal rib teeth 20 are formed in a recessed arc shape from the front end 21 of the tooth mount 15 through the rear end thereof along the recess 16 formed between the pair of lateral pinching teeth 11. Forming the longitudinal rib teeth 20 in a recessed arc shape enables an angle θ (refer to FIG. 1) between the front end 21 of the tooth mount 15 and the front parts of the longitudinal rib teeth 20 to have an acute angle. Accordingly, it is possible to reliably pinch a circular arc peripheral surface of a screw head by the front parts of the longitudinal rib teeth 20. Further, the front parts of all of the four longitudinal rib teeth 20 face the front end 21 of the tooth mount 15. When the first arm 1 and the second arm 2 are gripped up to the limit position, mountain portions of the longitudinal rib teeth 20 of the arm 1 and mountain portions of the longitudinal rib teeth 20 of the arm 2 vertically face each other with a small gap interposed therebetween in parallel to a horizontal plane passing through the tool central axis 8. In this state, the height of the four longitudinal rib teeth 20 from the recess 16 is always constant in any cross-sectional position of the longitudinal rib teeth 20. Each of the tooth mounts 15 has inclined flanks 22 which are formed on the right and left sides of the front end 21. Each of the flanks 22 is inclined in a tapered shape toward the front end of the jaw 4. The mountain portions of the longitudinal rib teeth 20 are formed at positions recessed from the valley portions 17b of the lateral rib teeth 17.

Forming the longitudinal rib teeth 20 into a recessed arc shape and allowing the front parts thereof to face the front ends 21 of the tooth mounts 15 in the above manner enable the longitudinal rib teeth 20 to reliably capture and pinch the circular arc peripheral surface of a screw head when the jaws 4 are open and the screw head is pinched by the pair of longitudinal pinching teeth 12. Thus, when detaching a screw in which a cross-shaped operation groove formed on the head thereof has been crushed or a screw having a rusted thread, it is possible to press the longitudinal rib teeth 20 against the circular arc peripheral surface of the screw head or allow the longitudinal rib teeth 20 to dig into the circular arc peripheral surface of the screw head to thereby reliably operate the screw to rotate in a loosening direction. In particular, even a truss screw or an oval head screw having a low height from the circular arc peripheral surface of a screw head to a screw fastening surface can be reliably removed by bringing the front ends 21 of the tooth mounts 15 into intimate contact with the screw fastening surface to thereby allow the front parts of the longitudinal rib teeth 20 to dig into the circular arc peripheral surface of the screw head.

Each of the rear pinching teeth 13 includes a plurality of (four) rear rib teeth 25 which are perpendicular to the tool central axis 8 and elongated in the right-left direction. The rear rib teeth 25 of the first arm 1 and the rear rib teeth 25 of the second arm 2 vertically face each other with a small gap interposed therebetween in parallel to the horizontal plane passing through the tool central axis 8 when the first arm 1 and the second arm 2 are gripped up to the limit position (when the cutting pliers are in a closed posture).

As shown in FIGS. 1 and 3, when a region located on the front side with respect to the rearmost lateral rib tooth 17 in each of the jaws 4, 4 is defined as a front region 23, the front regions 23, 23 of both of the jaws 4, 4 contactlessly face each other in the closed posture obtained by gripping both of the arms 1, 2 up to the gripping limit defined by the stopper 18. More specifically, when the cutting pliers are in the closed posture, the mountain portions 17a of the lateral rib teeth 17 of one of the jaws 4 enter the valley portions 17b of the lateral rib teeth 17 of the other jaw 4 so that the mountain portions 17a and the valley portions 17b vertically face each other with a small gap interposed therebetween, and the front regions 23, 23 of both of the jaws 4, 4 including the lateral pinching teeth 11 and the longitudinal pinching teeth 12 contactlessly face each other.

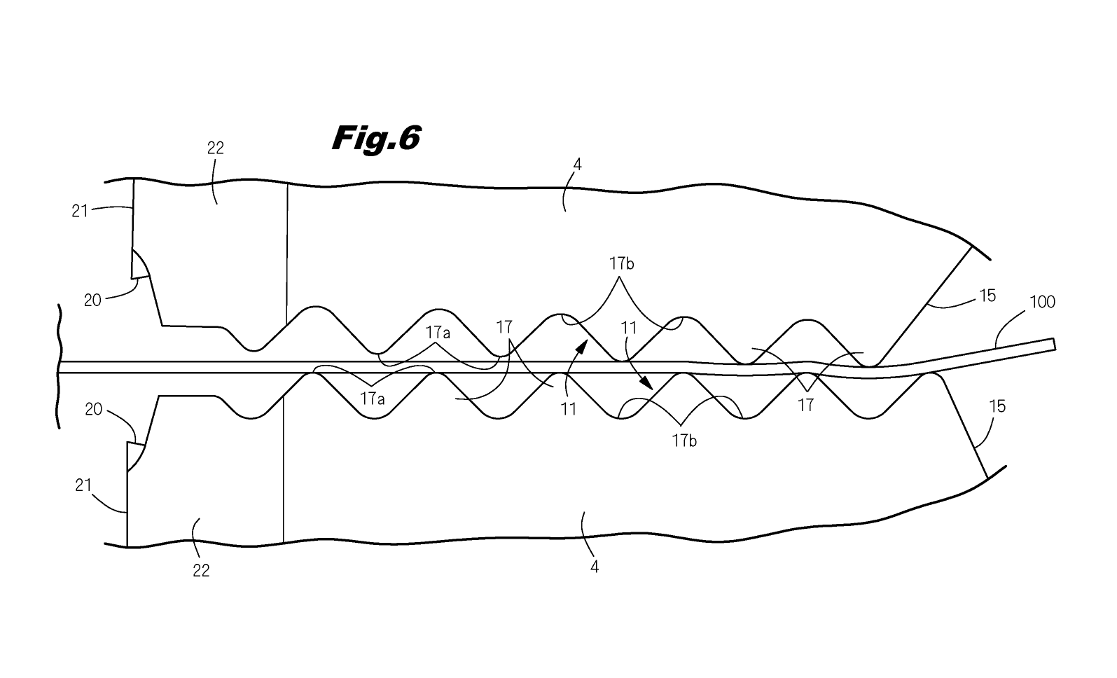

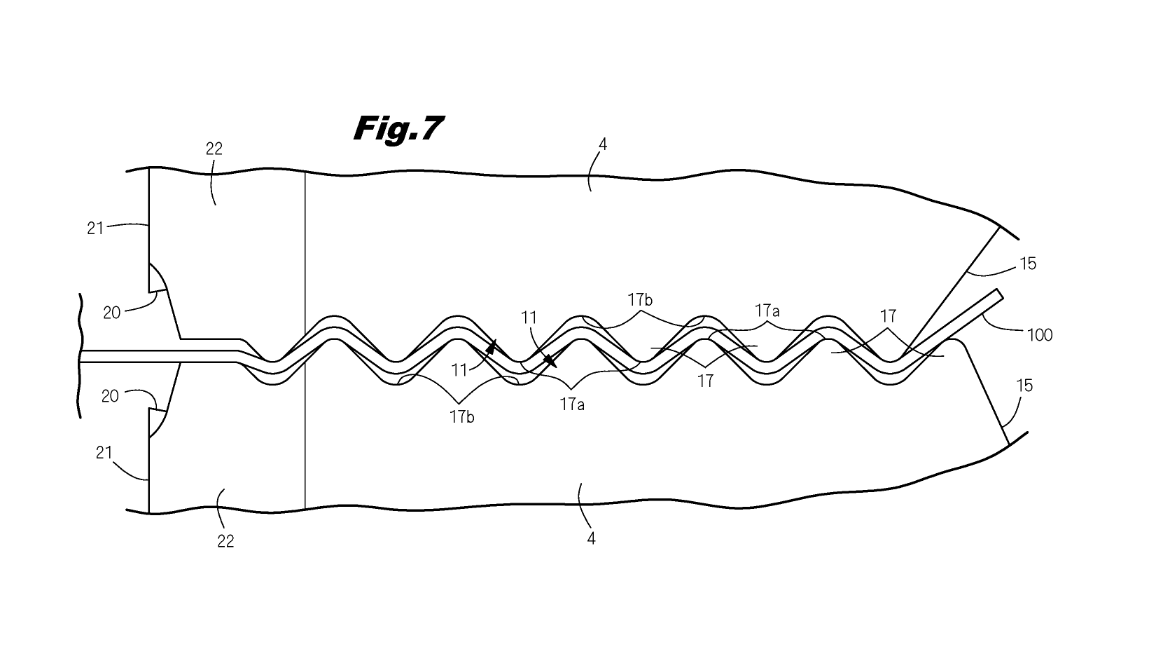

Next, a grasping function using the lateral pinching teeth 11 of the cutting pliers will be described with reference to FIGS. 6 and 7. When, for example, the thin sheet body 100 is pinched by the lateral pinching teeth 11, upper and lower faces of an end part of the sheet body 100 is pinched by the pair of lateral pinching teeth 11 as shown in FIG. 6. Accordingly, lateral rib teeth 17 located on the rear side of each of the tooth mounts 15 come into contact with the sheet body 100, and the sheet body 100 is received by the mountain portions 17a of the upper and lower lateral rib teeth 17 located at positions shifted by a half pitch. When the grips 5 are further gripped from this state, as illustrated in FIG. 7, each of the mountain portions 17a of the upper and lower lateral rib teeth 17 enters the valley portion 17b of the corresponding lateral rib tooth 17. Accordingly, it is possible to plastically deform the sheet body 100 into a continuous mountain-valley shape. As described above, the cutting pliers are capable of firmly pinching the sheet body 100 by the pair of upper and lower lateral pinching teeth 11 and therefore exhibiting an excellent grasping function. Further, it is possible to accurately perform a secondary operation, for example, pulling the sheet body 100 to drag the entire sheet body 100 out of the attaching portion or bending the pinched portion while firmly pinching the sheet body 100. Examples of an object to be grasped by the cutting pliers include, in addition to a sheet body made of metal, a plastic sheet, a metal wire material, a cord , a leather sheet, a rubber sheet, a plastic piece, and a fabric.

In addition, as described above, the front regions 23, 23 of both of the jaws 4, 4 contactlessly face each other when the cutting pliers according to the present embodiment are in the closed posture obtained by gripping both of the arms 1, 2 up to the gripping limit defined by the stopper 18. Such a configuration in which the front regions 23, 23 of both of the jaws 4,4 contactlessly face each other in the closed posture in this manner prevents only some of the lateral rib teeth 17 located in the front regions 23, 23 from disadvantageously serving as a point of action during the grasping operation. Accordingly, a more stable grasping function is exhibited. That is, for example, when a configuration in which some of the lateral rib teeth 17 located in the front regions 23, 23 of both of the jaws 4, 4 make contact with each other in the closed posture is employed, only the lateral rib teeth 17 making contact with each other are likely to serve as the point of action during the grasping operation. Thus, it is not possible to pinch an object at a plurality of points (the mountain portions 17a of the lateral rib teeth 17). As a result, a stable grasping function may not be exhibited. On the other hand, when the front regions 23, 23 of both of the jaws 4, 4 do not make contact with each other in the closed posture as in the present embodiment, it is possible to effectively prevent deviation of the point of action during the grasping operation. Thus, it is possible to pinch an object at a plurality of points to thereby more stably exhibit a grasping function.

Next, a cutting function of the cutting pliers according to the present embodiment will be described with reference to FIGS. 2 and 3. As described above, in the cutting pliers according to the present embodiment, the gripping limit of both of the arms 1, 2 is defined by the cutting blades 10, 10 serving as the stopper 18. Further, even when the cutting pliers are in the closed posture in the gripping limit, the front regions 23, 23 of both of the jaws 4, 4 including the lateral pinching teeth 11 and the longitudinal pinching teeth 12 are not in contact with each other. In this manner, in the cutting pliers according to the present embodiment, although the lateral pinching teeth 11 are formed in the front regions 23, the cutting blades 10, 10 first abut on each other to define the gripping limit. Thus, it is possible to reliably obtain a cutting function deriving from the cutting blades 10, 10. More specifically, in the cutting pliers according to the present embodiment, the front regions 23, 23 of both of the jaws 4, 4 are always not in contact with each other including when the cutting pliers are in the closed posture and the cutting blades 10, 10 always first abut on each other during the gripping operation. Thus, the existence of the lateral pinching teeth 11 and the longitudinal pinching teeth 12 formed in the front regions 23, 23 does not hinder the cutting function deriving from the cutting blades 10, 10. Therefore, it is possible to reliably obtain the cutting function deriving from the cutting blades 10, 10.

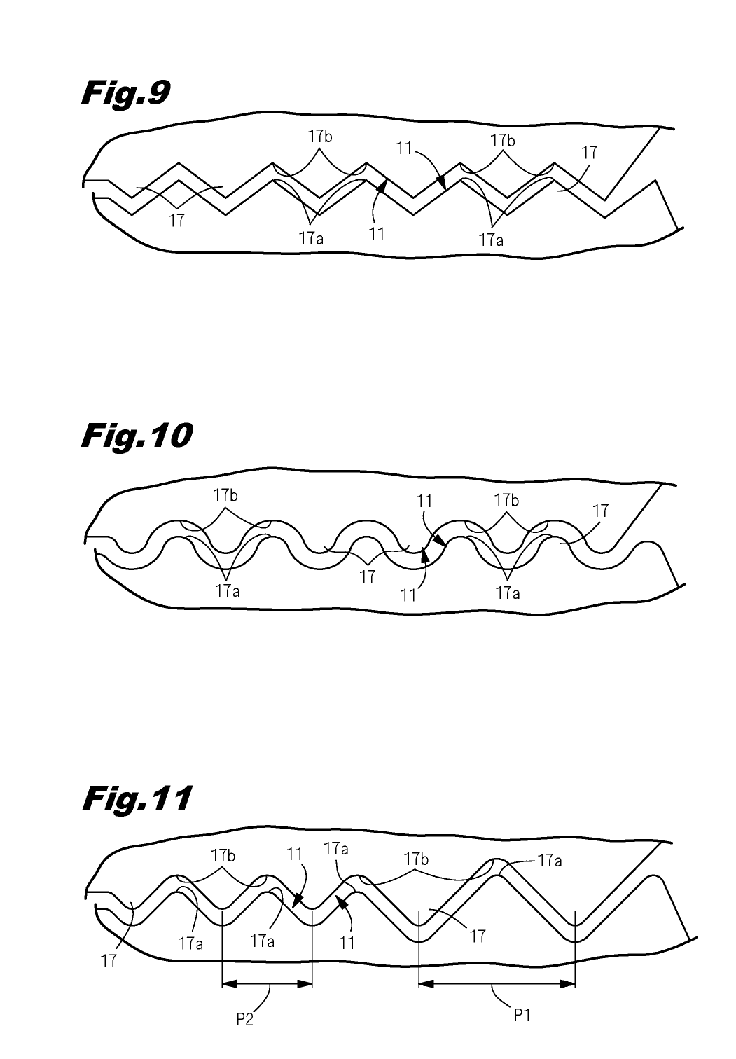

The lateral rib teeth 17 of the cutting pliers may be modified as shown in FIGS. 9 to 14. In the following description, components that are the same as those in the first embodiment will be designated by the same reference numerals and description thereof will be omitted. A modification shown in FIG. 9 differs from the first embodiment in that tips of mountain portions 17a of lateral rib teeth 17 are formed to be external corners that are not rounded and bottom ends of valley portions 17b thereof are formed to be internal corners that are not rounded.

A modification shown in FIG. 10 differs from the first embodiment in that the radius of rounded tips of mountain portions 17a and the radius of rounded bottom ends of valley portions 17b of lateral rib teeth 17 are increased so that the mountain portions 17a and the valley portions 17b are continuous with each other in a wave shape. Forming each lateral pinching tooth 11 into a continuous wave shape in this manner makes it possible to gently deform the sheet body 100 while firmly pinching the sheet body 100 by the lateral pinching teeth 11. Thus, such a configuration is suitable for preventing the sheet body 100 from being damaged.

A modification shown in FIG. 11 differs from the first embodiment in that each lateral pinching tooth 11 includes two kinds of lateral rib teeth 17 having large and small different tooth pitches P1, P2 and lateral rib teeth 17 having a large tooth pitch P1 is arranged on the rear side of the tooth mount 15. Such a configuration in which the lateral pinching teeth 11 include two kinds of lateral rib teeth 17 having the large and small different tooth pitches P1 and P2 makes it possible to selectively use a usage form of pinching the sheet body 100 only by front parts of the lateral pinching teeth 11 having the small tooth pitch P2 and a usage form of pinching the sheet body 100 by the entire lateral pinching teeth 11. Further, pinching the sheet body 100 by the lateral rib teeth 17 having the large tooth pitch P1 increases the contact area between the lateral rib teeth 17 and the sheet body 100. Accordingly, it is possible to reliably prevent the lateral rib teeth 17 and the sheet body 100 from relatively slipping on each other. An arrangement form of a plurality of kinds of lateral rib teeth 17 having different tooth pitches P1, P2 is not limited to the form illustrated in FIG. 11, and may be freely modified as necessary.

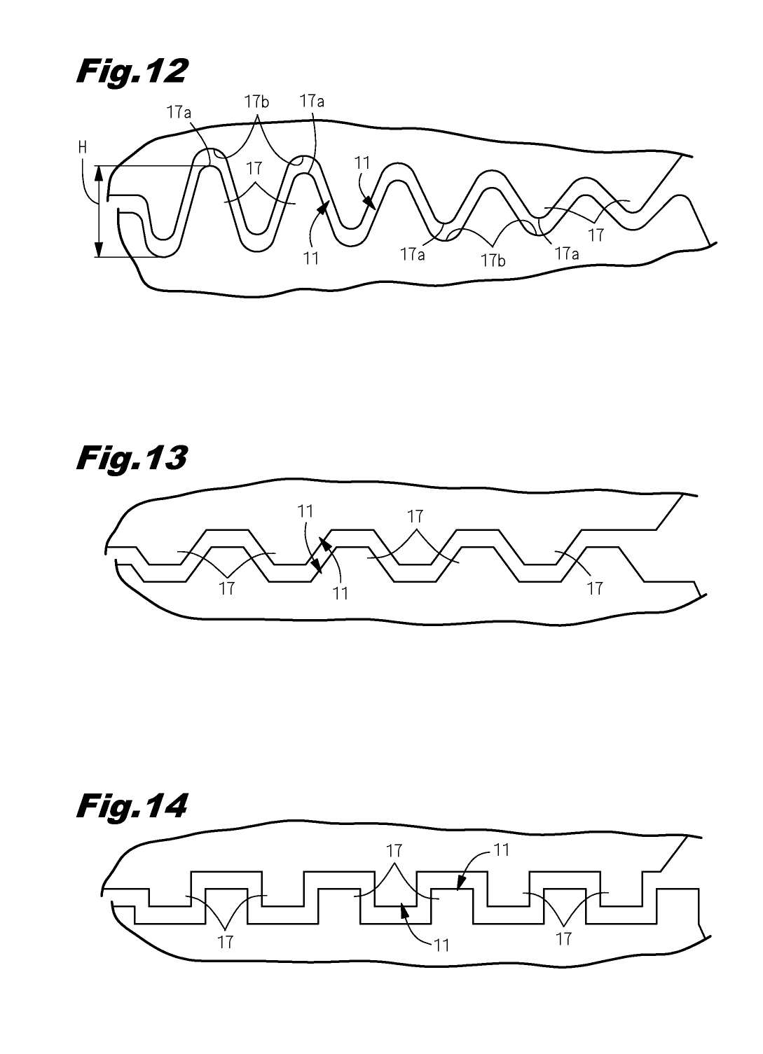

In FIG. 12, the tooth pitch P is constant in all lateral rib teeth 17. However, a modification shown in FIG. 12 differs from the first embodiment in that the tooth height H of the lateral rib teeth 17 is gradually reduced from the front side toward the rear side of the tooth mount 15 in each lateral pinching tooth 11. Such a configuration in which the lateral pinching teeth 11 include a plurality of kinds of lateral rib teeth 17 having different tooth heights H makes it possible to selectively use a usage form of pinching the sheet body 100 only by front parts of the lateral pinching teeth 11 having a large tooth height H and a usage form of pinching the sheet body 100 by the entire lateral pinching teeth 11 in the same manner as the lateral pinching teeth 11 of FIG. 11. Further, pinching the sheet body 100 by the lateral rib teeth 17 having a large tooth height H increases the contact area between the lateral rib teeth 17 and the sheet body 100. Accordingly, it is possible to reliably prevent the lateral rib teeth 17 and the sheet body 100 from relatively slipping on each other. An arrangement form of a plurality of kinds of lateral rib teeth 17 having different tooth heights H is not limited to the form illustrated in FIG. 12, and may be freely modified as necessary.

A modification shown in FIG. 13 differs from the first embodiment in that each lateral pinching tooth 11 includes lateral rib teeth 17 each having an isosceles trapezoidal shape in side view. A modification shown in FIG. 14 differs from the first embodiment in that each lateral pinching tooth 11 includes lateral rib teeth 17 each having a quadrangular shape in side view. The shape of lateral rib teeth 17 in side view may be freely selected as necessary and may be a shape other than the above shapes.

### Second Embodiment

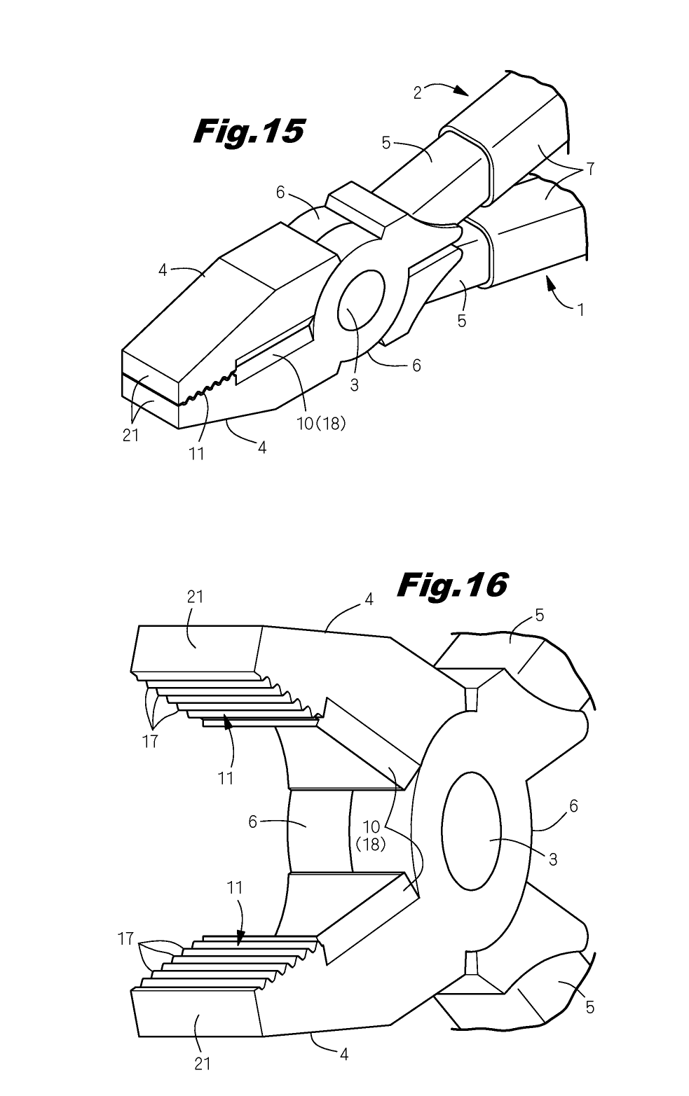

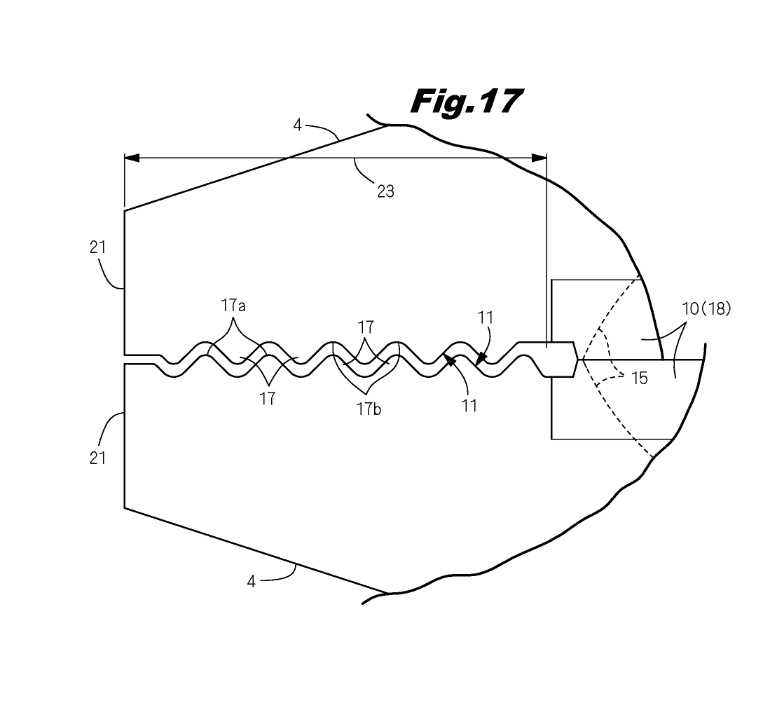

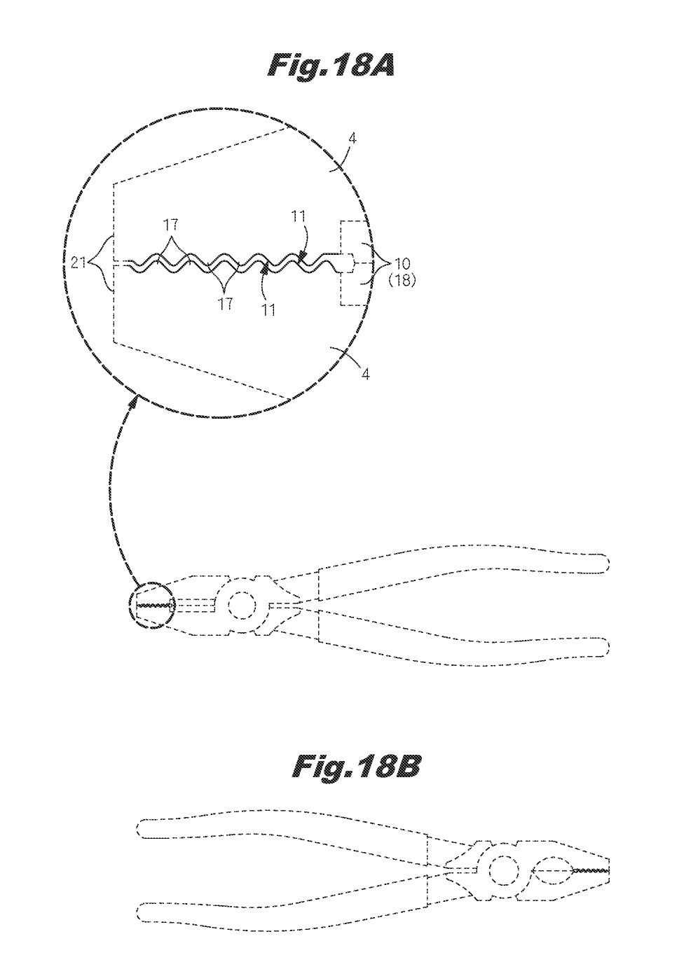

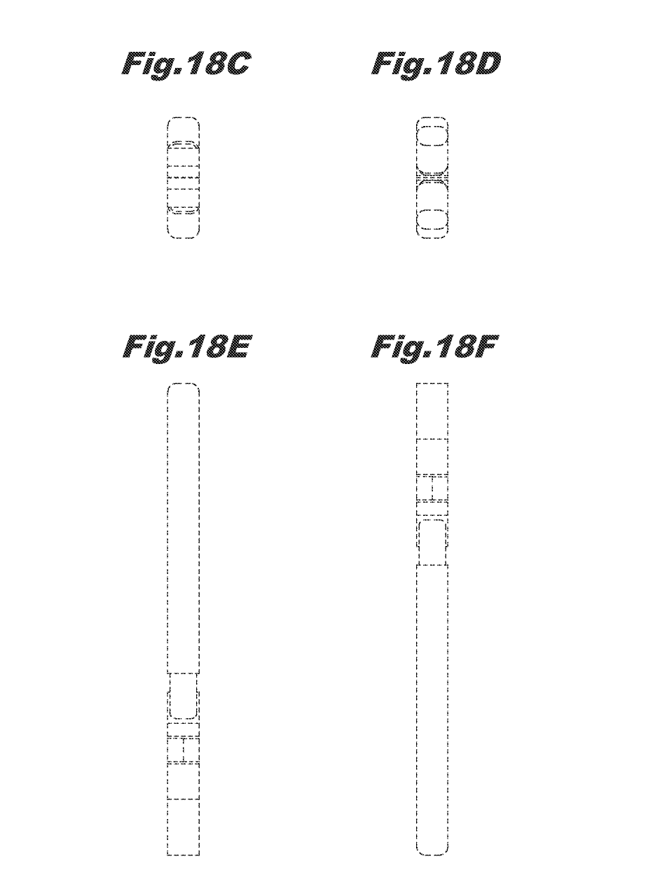

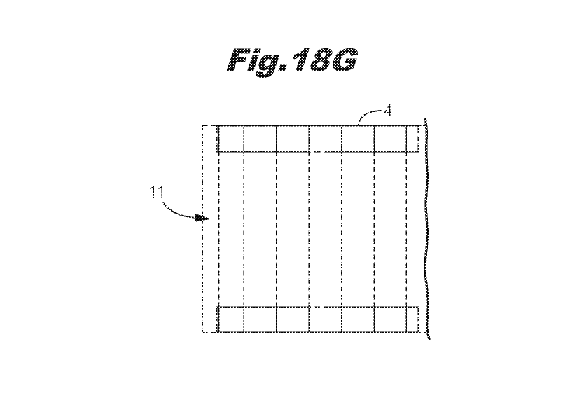

FIGS. 15 to 18G show a second embodiment in which the present invention is applied to cutting pliers. In the second embodiment, the longitudinal pinching teeth 12 of the first embodiment are not provided, and lateral rib teeth 17 of lateral pinching teeth 11 are formed on the entire opposed surfaces of jaws 4 which vertically face each other. Further, the front-rear length of each cutting blade 10 is made longer than that of the first embodiment and each of the lateral pinching teeth 11 is formed continuously from the front end of the corresponding cutting blade 10. FIGS. 18A to 18F include six views showing the appearance of the cutting pliers according to the second embodiment. Also in the cutting pliers according to the second embodiment, the lateral rib teeth 17 may be modified as shown in FIGS. 9 to 14.

### Third Embodiment

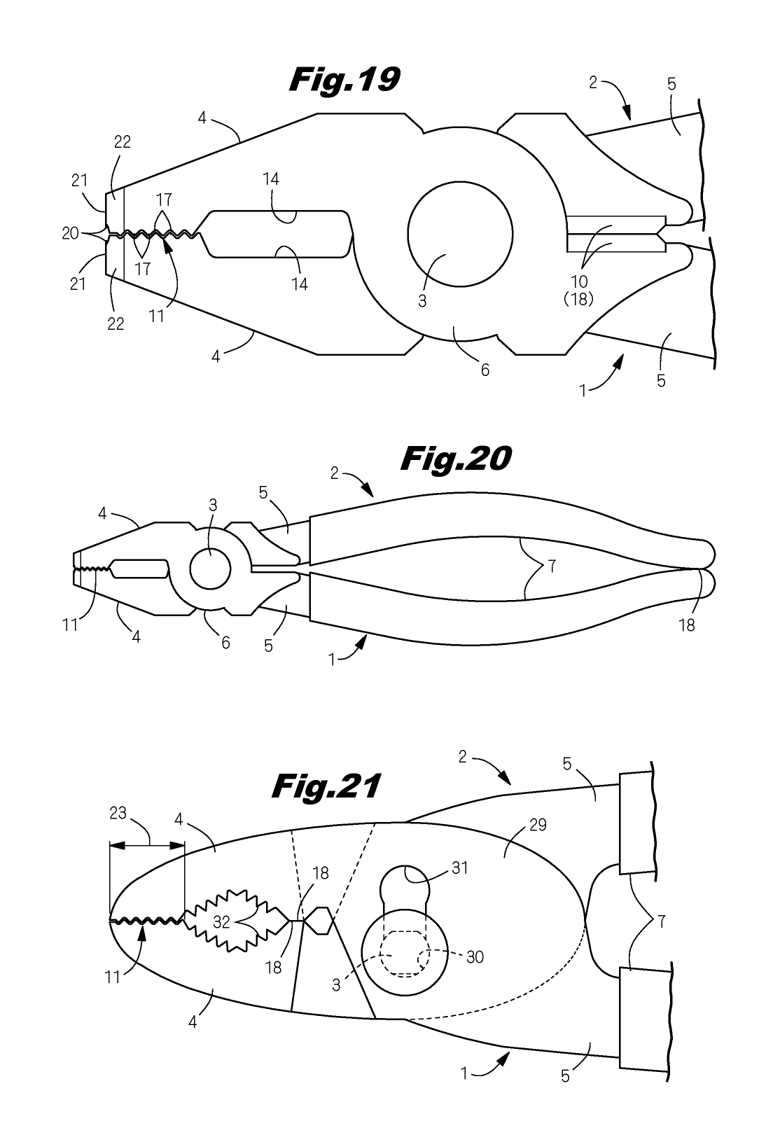

FIG. 19 shows a third embodiment of the cutting pliers in which the structure of the stopper 18 is modified. In the third embodiment, cutting blades 10 are formed on opposed surfaces of jaws 4 adjacent to coupling bosses 6 and grips 5, and the cutting blades 10 also serve as the stopper 18. When the cutting blades 10 are formed adjacent to the grips 5 in this manner, the front-rear length of each relief recess 14 increases. Thus, it is possible to pinch the sheet body 100 by lateral pinching teeth 11 even at a position sufficiently away from the end of the sheet body 100 with no difficulty.

FIG. 20 shows a modification of the cutting pliers in which the structure of the stopper 18 is further modified. In this modification, when a first arm 1 and a second arm 2 are gripped up to the limit position, rear ends of grip bodies 7 come into contact with each other to serve as the stopper 18. As described above, the stopper 18 may be arranged between the pair of arms 1 and 2 or between the pair of coupling bosses 6. Thus, it is not necessary for the cutting blades 10 to also serve as the stopper 18.

### Fourth Embodiment

FIG. 21 shows a fourth embodiment in which the present invention is applied to combination pliers. As with the cutting pliers, the combination pliers include a first arm 1 and a second arm 2 which are combined in an X shape by a coupling shaft 3. In the combination pliers, two eyeglass-shaped coupling holes 30, 31 are formed on a jaw base 29 of each of the arms 1, 2. An opening angle of jaws 4 can be changed to a large angle or a small angle by engaging the coupling shaft 3 with either the coupling holes 30 or 31. Further, lateral pinching teeth 11 are formed on the front parts of opposed surfaces of the jaws 4, and recessed arc pinching teeth 32 are formed continuously from the respective lateral pinching teeth 11 on the rear side thereof. Accordingly, it is possible to reliably pinch even an object having a large size by the recessed arc pinching teeth 32.

Stoppers 18, 18 are formed on opposed surfaces of the arms 1, 2 between the recessed arc pinching teeth 32 and the coupling shaft 3. The stoppers 18, 18 first abut on each other to restrict the gripping limit when the arms 1, 2 are gripped up to the gripping limit. Further, front regions 23, 23 of both of the jaws 4, 4 contactlessly face each other when the combination pliers are in a closed posture obtained by gripping the arms 1, 2 up to the gripping limit defined by the stoppers 18, 18 first abutting on each other with the coupling shaft engaged with the coupling holes 30.

### Fifth Embodiment

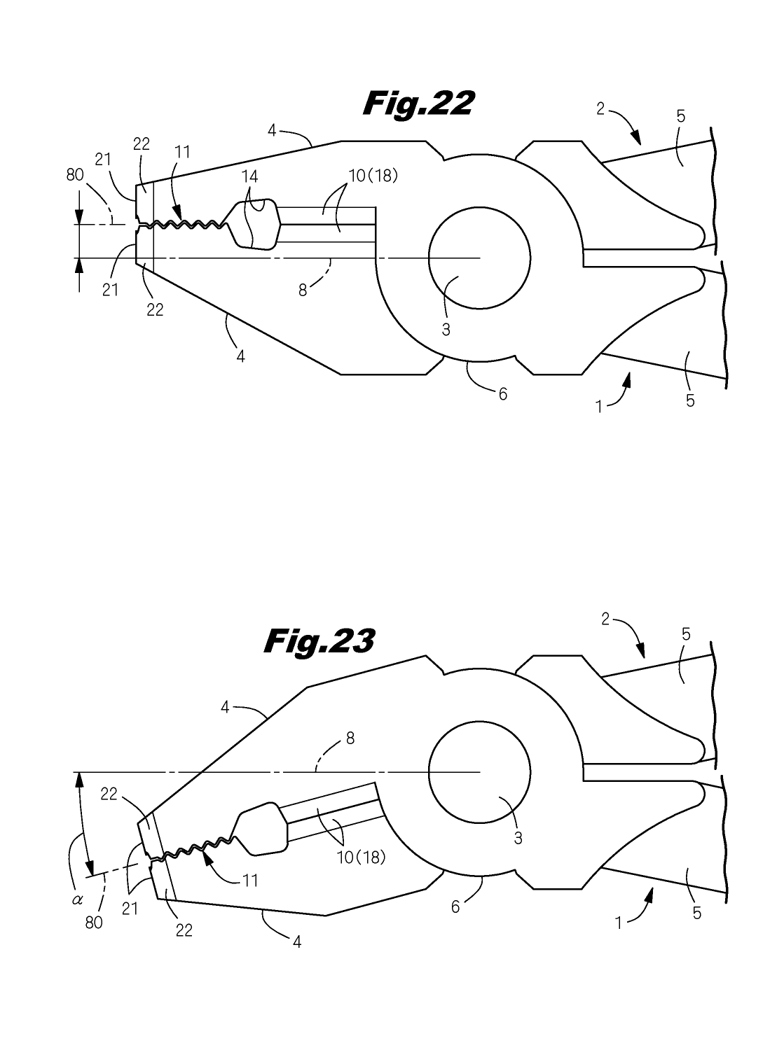

FIG. 22 shows a fifth embodiment in which the present invention is applied to cutting pliers. In the fifth embodiment, a jaw 4 of a first arm 1 and a jaw 4 of a second arm 2 are asymmetrically formed so that a cutting center of cutting blades 10 and a pinching center 80 of lateral pinching teeth 11 are shifted toward the upper side (or the lower side) of a tool central axis 8 and the pinching center 80 and the tool central axis 8 are parallel to each other. The other points are the same as those of the first embodiment. Thus, components that are the same as those in the first embodiment will be designated by the same reference numerals and description thereof will be omitted.

### Sixth Embodiment

FIG. 23 shows a sixth embodiment in which the present invention is applied to cutting pliers. In the sixth embodiment, as with the fifth embodiment, a jaw 4 of a first arm 1 and a jaw 4 of a second arm 2 are asymmetrically formed. In addition, a cutting center of cutting blades 10 and a pinching center 80 of lateral pinching teeth 11 are inclined by an angle a with respect to a tool central axis 8 so that the cutting center of the cutting blades 10 and the pinching center 80 of the lateral pinching teeth 11 pass through the center of a coupling shaft 3. The other points are the same as those of the first embodiment. Thus, components that are the same as those in the first embodiment will be designated by the same reference numerals and description thereof will be omitted. As can be understood from the fifth and sixth embodiments, the cutting center of the cutting blades 10 and the pinching center 80 of the lateral pinching teeth 11 are not necessarily arranged on the tool central axis 8.

### Seventh Embodiment

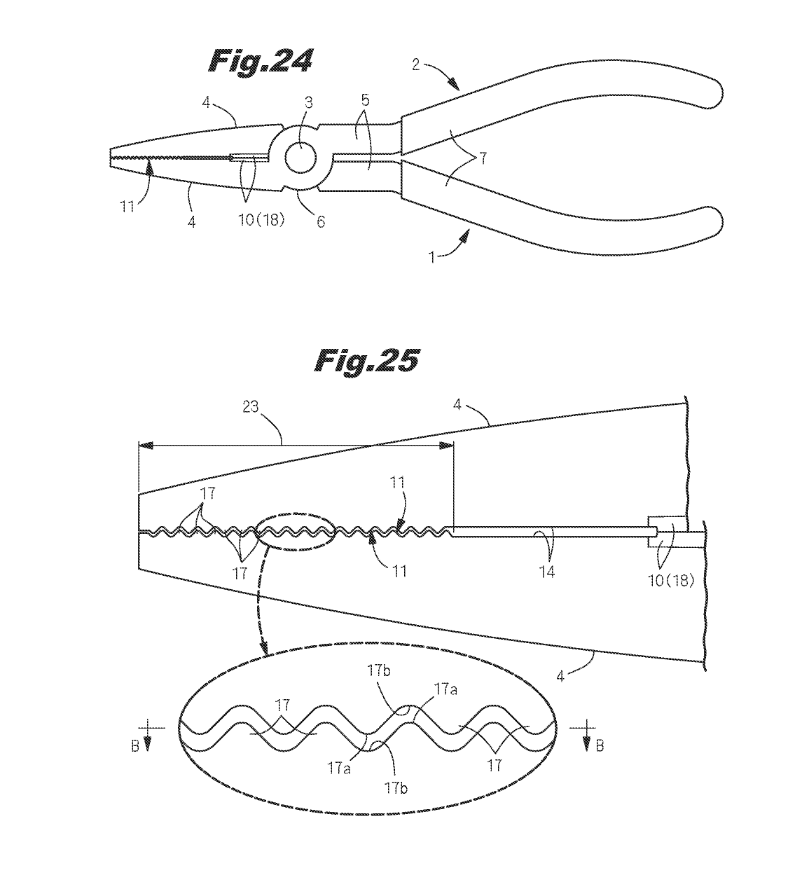

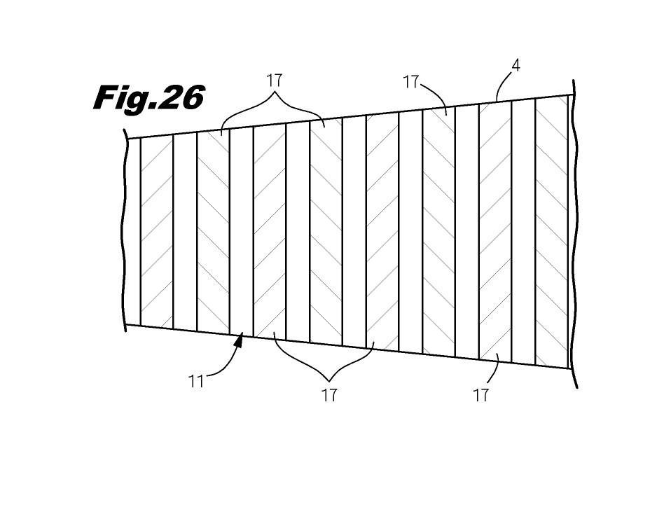

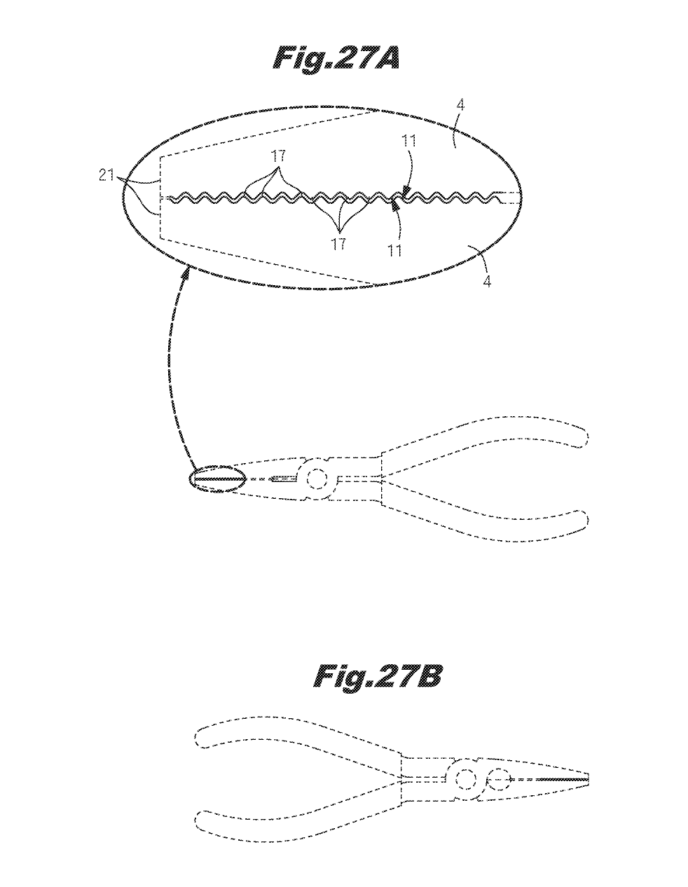

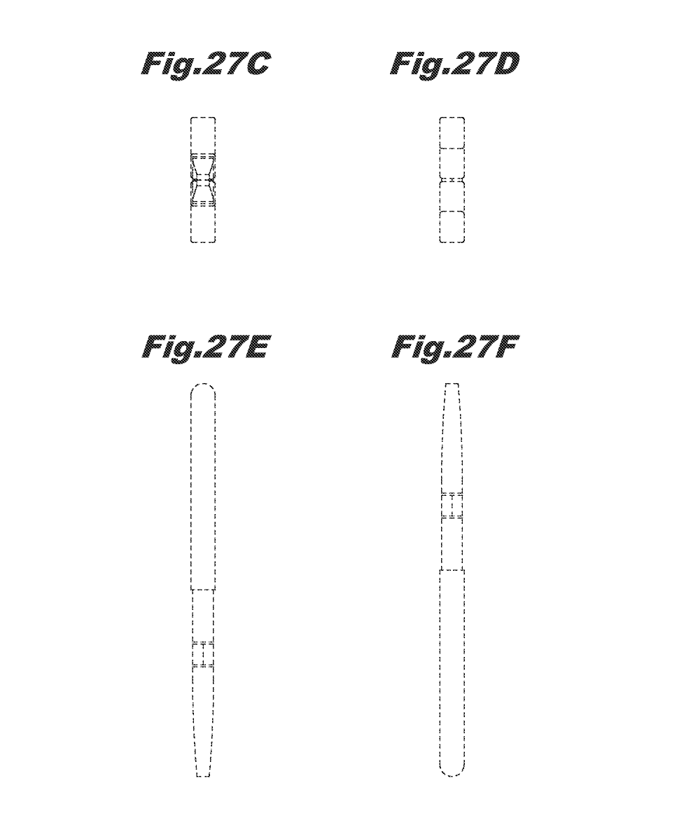

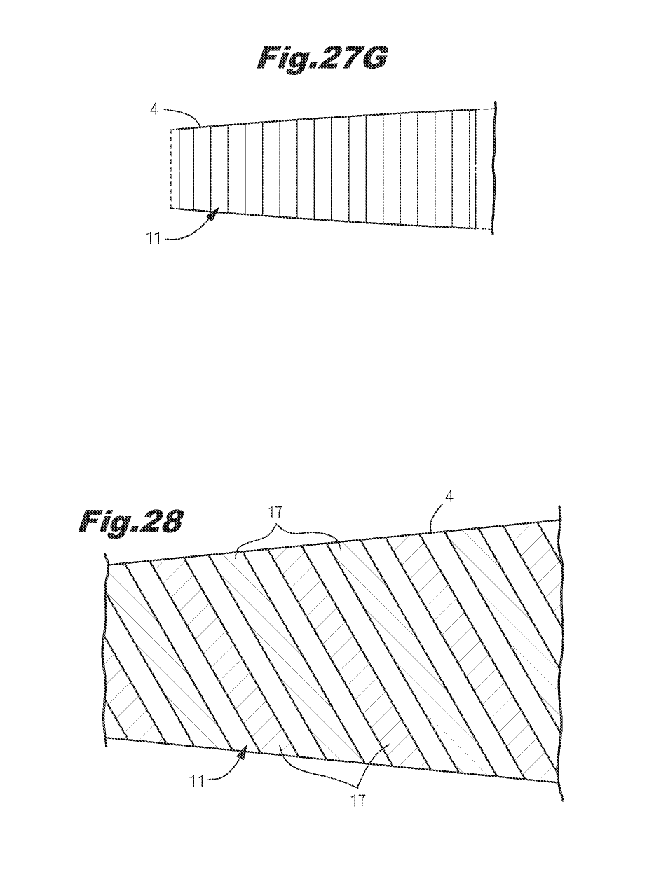

FIGS. 24 to 27G show a seventh embodiment in which the present invention is applied to needle-nose pliers. In the seventh embodiment, as with the first embodiment, a first arm 1 and a second arm 2 are vertically symmetrically formed. Lateral pinching teeth 11 are formed on opposed surfaces of wedged jaws 4. Each of the lateral pinching teeth 11 is formed in a region from the tip of the corresponding jaw 4 through a position across the center thereof. FIGS. 27A to 27F include six views showing the appearance of the needle-nose pliers according to the seventh embodiment. A region for forming the lateral pinching teeth 11 may be appropriately modified.

In the seventh embodiment, the right-left width of each of the jaws 4 is narrow. Thus, it is not possible to make the meshing length between a pair of lateral rib teeth 17 long. In view of this, as shown in FIG. 28, the lateral rib teeth 17 are allowed to obliquely intersect the tool central axis 8 so that the meshing length between a pair of lateral rib teeth 17 can be made longer. The lateral rib teeth 17 of the pinching tools in the third to seventh embodiments may be modified as shown in FIGS. 9 to 14.

The shift amount in the front-rear direction between the lateral rib teeth 17 of the first arm 1 and the lateral rib teeth 17 of the second arm 2 is not necessarily half the tooth pitch P, and may be set to any amount within the range of the tooth pitch P. In short, it is only required that the mountain portions 17a of the lateral rib teeth 17 formed on one of the jaws 4 enter the valley portions 17b of the lateral rib teeth 17 formed on the other jaw 4 when the first arm 1 and the second arm 2 are gripped up to the limit position. The front ends 21 of the upper and lower tooth mounts 15 may be formed to have a curved shape projecting forward when the first arm 1 and the second arm 2 are gripped up to the limit position.

In FIG. 5, the right and left lateral rib teeth 17 are formed in parallel to each other in the front-rear direction. However, the right and left lateral rib teeth 17 may be inclined in opposite directions with respect to the tool central axis 8 so that the right and left lateral rib teeth 17 can be formed in a truncated chevron shape or a reverse truncated chevron shape. Further, the lateral pinching tooth 11 may be formed only on either right or left side of the opposed surface of each of the jaws 4, and the longitudinal pinching tooth 12 maybe formed on the other side of the opposed surface.

What is claimed is:

1. A pinching tool comprising:
a pair of arms (1, 2) each having a jaw (4) arranged on an front end side and a grip (5) arranged on a rear end side;
coupling bosses (6) and a coupling shaft (3) for coupling the arms (1, 2) in an X shape;
lateral pinching teeth (11) formed on front parts of opposed surfaces of the jaws (4) of both of the arms (1, 2); and
a stopper (18) for restricting a gripping limit of the jaws (4) of both of the arms (1, 2) when the grips (5) are gripped, the stopper (18) being disposed between the arms (1, 2), wherein
each of the lateral pinching teeth (11) includes a plurality of lateral rib teeth (17) extending in a direction intersecting a tool central axis (8) extending in a front-rear direction, the lateral rib teeth (17) being continuous in a mountain-valley shape,
when a region located on the front side with respect to the rearmost lateral rib tooth (17) of each of the jaws (4) is defined as a front region (23), the stopper (18) is disposed on a portion excepting the front region (23),
the lateral rib teeth (17) formed on one of the jaws (4) and the lateral rib teeth (17) formed on the other jaw (4) are shifted in the front-rear direction, and
mountain portions (17a) of the lateral rib teeth (17) of one of the jaws (4) enter valley portions (17b) of the lateral rib teeth (17) of the other jaw (4) and the front regions (23, 23) of both of the jaws (4, 4) including the lateral rib teeth (17) contactlessly face each other in a closed posture obtained by gripping the arms (1, 2) up to the gripping limit defined by the stopper (18).

2. The pinching tool according to claim 1, wherein
a pair of cutting blades (10, 10) is formed on opposed surfaces of the jaws (4) adjacent to the coupling bosses (6), and
the cutting blades (10, 10) come into contact with each other to function as the stopper (18).

3. The pinching tool according to claim 1, wherein
the lateral pinching teeth (11) formed on both of the jaws (4) include lateral rib teeth (17) having the same shape, the same size, and the same tooth pitch (P),
the tooth pitch (P) of the lateral rib teeth (17) formed on one of the jaws (4) and the tooth pitch (P) of the lateral rib teeth (17) formed on the other jaw (4) are shifted by half the tooth pitch (P) in the front-rear direction, and
tips of the mountain portions (17a) of the lateral rib teeth (17) formed on one of the jaws (4) and bottom ends of the valley portions (17b) of the lateral rib teeth (17) formed on the other jaw (4) contactlessly face each other in the up-down direction in the closed posture.

4. The pinching tool according to claim 2, wherein
the lateral pinching teeth (11) formed on both of the jaws (4) include lateral rib teeth (17) having the same shape, the same size, and the same tooth pitch (P),
the tooth pitch (P) of the lateral rib teeth (17) formed on one of the jaws (4) and the tooth pitch (P) of the lateral rib teeth (17) formed on the other jaw (4) are shifted by half the tooth pitch (P) in the front-rear direction, and
tips of the mountain portions (17a) of the lateral rib teeth (17) formed on one of the jaws (4) and bottom ends of the valley portions (17b) of the lateral rib teeth (17) formed on the other jaw (4) contactlessly face each other in the up-down direction in the closed posture.

5. The pinching tool according to claim 1, wherein the lateral pinching tooth (11) of each of the jaws (4, 4) includes a plurality of kinds of lateral rib teeth (17) having different tooth pitches (P1, P2), the lateral rib teeth (17) being arranged along the tool central axis (8).

6. The pinching tool according to claim 3, wherein the tips of the mountain portions (17a) and the bottom ends of the valley portions (17b) of the lateral rib teeth (17) are rounded so that the lateral pinching tooth (11) of each of the arms (1, 2) is formed in a continuous wave shape in side view.

7. The pinching tool according to claim 4, wherein the tips of the mountain portions (17a) and the bottom ends of the valley portions (17b) of the lateral rib teeth (17) are rounded so that the lateral pinching tooth (11) of each of the arms (1, 2) is formed in a continuous wave shape in side view.

8. The pinching tool according to claim 3, wherein the lateral pinching tooth (11) of each of the arms (1, 2) includes a plurality of kinds of lateral rib teeth (17) having different tooth heights (H).

9. The pinching tool according to claim 4, wherein the lateral pinching tooth (11) of each of the arms (1, 2) includes a plurality of kinds of lateral rib teeth (17) having different tooth heights (H).

10. The pinching tool according to claim 3, wherein
tooth mounts (15) are formed in a projecting manner on front parts of opposed surfaces of the pair of jaws (4),
lateral pinching teeth (11) are formed on the right and left sides of each of the tooth mounts (15) and a longitudinal pinching tooth (12) is formed between the right and left lateral pinching teeth (11),
each of the lateral pinching teeth (11) includes a plurality of lateral rib teeth (17) extending perpendicular to the tool central axis (8), and
the longitudinal pinching tooth (12) includes a plurality of longitudinal rib teeth (20) elongated in the front-rear direction.

11. The pinching tool according to claim 4, wherein
tooth mounts (15) are formed in a projecting manner on front parts of opposed surfaces of the pair of jaws (4),
lateral pinching teeth (11) are formed on the right and left sides of each of the tooth mounts (15) and a longitudinal pinching tooth (12) is formed between the right and left lateral pinching teeth (11),
each of the lateral pinching teeth (11) includes a plurality of lateral rib teeth (17) extending perpendicular to the tool central axis (8), and
the longitudinal pinching tooth (12) includes a plurality of longitudinal rib teeth (20) elongated in the front-rear direction.

12. The pinching tool according to claim 10, wherein
a front end (21) of each of the tooth mounts (15) is formed in a flat surface perpendicular to the tool central axis (8), and
the longitudinal rib teeth (20) are formed in a recessed arc shape from the front end (21) through a rear end of each of the tooth mounts (15) and front parts of the longitudinal rib teeth (20) face the front end (21) of each of the tooth mounts (15).

13. The pinching tool according to claim 11, wherein
a front end (21) of each of the tooth mounts (15) is formed in a flat surface perpendicular to the tool central axis (8), and
the longitudinal rib teeth (20) are formed in a recessed arc shape from the front end (21) through a rear end of each of the tooth mounts (15) and front parts of the longitudinal rib teeth (20) face the front end (21) of each of the tooth mounts (15).
